(19) United States
(12) Patent Application Publication
(10) Pub. No.: US 2024/0152880 A1
(43) Pub. Date: May 9, 2024

(54) Multi-Channel Payment Method and System

(71) Applicant: OBOOK INC., New Taipei City (TW)

(72) Inventors: Chun-Kai Wang, Taipei City (TW); Chung-Han Hsieh, Taipei City (TW); Chun-Jen Chen, New Taipei City (TW); Po-Hua Lin, Miaoli County (TW); Wei-Te Lin, Taipei City (TW); Pei-Hsuan Weng, New Taipei City (TW); Mei-Su Wang, Taipei City (TW); I-Cheng Lin, Taipei City (TW); Cheng-Wei Chen, New Taipei City (TW)

(73) Assignee: OBOOK INC., NEW TAIPEI CITY (TW)

(21) Appl. No.: 18/108,678

(22) Filed: Feb. 13, 2023

(30) Foreign Application Priority Data
Nov. 8, 2022 (TW) 111142512

(51) Int. Cl. G06Q 20/02; G06Q 20/36; G06Q 20/38; G06Q 20/40; G06Q 30/0601

(52) U.S. Cl. CPC G06Q 20/027; G06Q 20/36; G06Q 20/382; G06Q 20/389; G06Q 20/40145; G06Q 30/0609

(57) ABSTRACT

A multi-channel payment method for a multi-channel payment system comprises the payer or the payee who initiated the payment request logs in to the multi-channel payment system; the payer or the payee who initiated the payment request placing an order in the multi-channel payment system, wherein the order comprises a designated payment gateway; the multi-channel payment system determining a predicted fee of the order according to the designated payment gateway, past order records, and a real-time exchange rate; the multi-channel payment system performing an anti-money laundering verification of the order; the payer reviewing the order and the predicted fee through a multiple auditing method; and the multi-channel payment system executing payment from the payer to the payee according to the order and the designated payment gateway, and storing a payment detail of the order.

### BACKGROUND OF THE INVENTION

### 1. Field of the Invention

The present invention relates to a multi-channel payment method and system, and more particularly, to a multi-channel payment method and system capable of integrating order generating, order auditing and heterogeneous payment gateways.

### 2. Description of the Prior Art

With the development of social economy, the change of transaction mode and the popularization of cross-border transactions, the way to make payment changes rapidly, and the content used for payment becomes more and more diversified. Consumers, merchants and suppliers need to face a lot of new issues. For example, the way to make payment changes from traditional bank transfer or credit card payment to virtual credit card, electronic payment, third-party payment, etc. The content used for payment includes not only the fiat currency of various countries but also stablecoin, central bank digital currency (CBDC), or other cryptocurrencies.

In general, merchants may need to pay for different suppliers through different platforms while making payments. When conducting cross-border transactions, the merchants also need to consider different exchange rates and different fees required by different payment types, time spent by the transaction and security issues. In addition, in the past, there were separate systems for the review of orders and the actual execution of payment. The same order needs to be logged on different systems repeatedly or transferred in paper between different auditors and financial personnel, resulting in redundant and complicated payment operations. In addition, general payment platforms often only allow the payer to unilaterally make a payment (push payment), or only allow the payee to unilaterally issue payment request (pull payment), which makes the payment procedure inflexible.

In view of this, it is necessary to improve the existing payment system so that users may perform payment operations smoothly without having to deal with cumbersome payment details and security concerns.

### SUMMARY OF THE INVENTION

Therefore, the present invention is to provide a multi-channel payment method and system to reduce the technical threshold of integrating new payment gateways and improve the utilization convenience through an extension. In addition, the multi-channel payment method and system of the present invention has high degree of integration, flexibility and security of payment operations, which improves the shortcomings of conventional technologies.

The present invention discloses a multi-channel payment system, wherein the multi-channel system integrates multiple payment gateway services for providing domestic remittance, cross-border remittance, virtual credit card, and digital currency remittance. The multi-channel payment system comprising a user interface module modularized by a plurality of extensions, for executing payment from a payer to a payee according to a payment order placed by the payer/payee; wherein each single extension represents a payment channel connected with a payment gateway service of the multiple payment gateway services via an application programming interface (API) communication protocol defining essential information of payment APIs from the multiple payment gateway services; each extension is selectively activated by the payer/payee and is enabled only when an identity of the payer/payee has been verified, the extension generates the payment order placed by the payer/payee to initiate a payment request, and the API communication protocol is used for communicating between the payment APIs of the multiple payment gateway services and the multi-channel payment system, wherein the API communication protocol verifies an authentication token to communicate with the payment gateway services and allow a payment remittance of the payment order; a fee-prediction module, feeding data to the user interface module, for determining a predicted remitting fee, an exchange rate, or a predicted transfer time of the payment order from a designated payment gateway service, past payment order records, and a real-time exchange rate provider; a compliance module communicating with the user interface module, for confirming the identity of the payer/payee verified by a Know Your Customer (KYC) verification service while applying each extension for the first time and confirming the payment order verified by an anti-money laundering (AML) verification service; a multiple auditing module, receiving the payment order from the compliance module, for reviewing, objecting, or permitting the payment order; a data storage module, for storing a user login information, the identity of the payer/payee, the payment order generated by each extension, and a payment result when the payment order is permitted by the multiple auditing module; and a transaction verification module, interacting with the user interface module and the data storage module for receiving a status of the payment order from the designated payment gateway service and showing the payment result by the user interface module.

The present invention further discloses a multi-channel payment method, wherein the multi-channel method integrates multiple payment gateway services for providing domestic remittance, cross-border remittance, virtual credit card, and digital currency remittance. The multi-channel payment method comprising executing, by a user interface module modularized by a plurality of extensions, payment from a payer to a payee according to a payment order placed by the payer/payee; wherein each single extension represents a payment channel connected with a payment gateway service of the multiple payment gateway services via an application programming interface (API) communication protocol defining necessary information of payment APIs from the multiple payment gateway services; each extension is selectively activated by the payer/payee and is enabled only when an identity of the payer/payee has been verified, the extension generates the payment order placed by the payer/payee to initiate a payment request, and the API communication protocol is used for communicating between the payment APIs of the multiple payment gateway services and the plurality of extensions, wherein the API communication protocol verifies an authentication token from the payment gateway services to allow a payment remittance of the payment order; feeding, by a fee-prediction module, data to the user interface module for determining a predicted remitting fee, an exchange rate, or a predicted transfer time of the payment order from a designated payment gateway service, past payment order records, and a real-time exchange rate provider; confirming, by a compliance module communicated with the user interface module, the identity of the payer/payee verified by a Know Your Customer (KYC) verification service while applying each extension for the first time and confirming the payment order verified by an anti-money laundering (AML) verification service; receiving, by a multiple auditing module, the payment order from the compliance module for reviewing, objecting, or permitting the payment order; storing, by a data storage module, a user login information, the identity of the payer/payee, the payment order generated by each extension, and a payment result when the payment order is permitted by the multiple auditing module; and interacting, by a transaction verification module, with the user interface module and the data storage module for receiving a status of the payment order from the designated payment gateway service and showing the payment result by the user interface module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a multi-channel payment system according to an embodiment of the present invention.

FIG. 2 is a schematic diagram of an architecture of the multi-channel payment system shown in FIG. 1.

FIG. 3 is a schematic diagram of a process according to an embodiment of the present invention.

FIG. 4A, FIG. 4B, FIG. 4C, FIG. 4D, FIG. 4E and FIG. 4F are schematic diagrams of a user interface for the multi-channel payment system shown in FIG. 1 to provide at least one available payment gateway for the user to select and activate.

FIG. 5 is a schematic diagram of a multi-person and single-line auditing process according to an embodiment of the present invention.

FIG. 6 is a schematic diagram of a multi-person and multi-line auditing process according to an embodiment of the present invention.

FIG. 7 is a schematic diagram of a multi-person online opinion exchange according to an embodiment of the present invention.

FIG. 8 is a schematic diagram of integrating various heterogeneous payment channels according to an embodiment of the present invention.

FIG. 9 is a schematic diagram of a device according to an embodiment of the present invention.

FIG. 10A and FIG. 10B are schematic diagrams of a user interface for the multi-channel payment system shown in FIG. 1 to provide a floating button for quickly accessing payment gateways.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”.

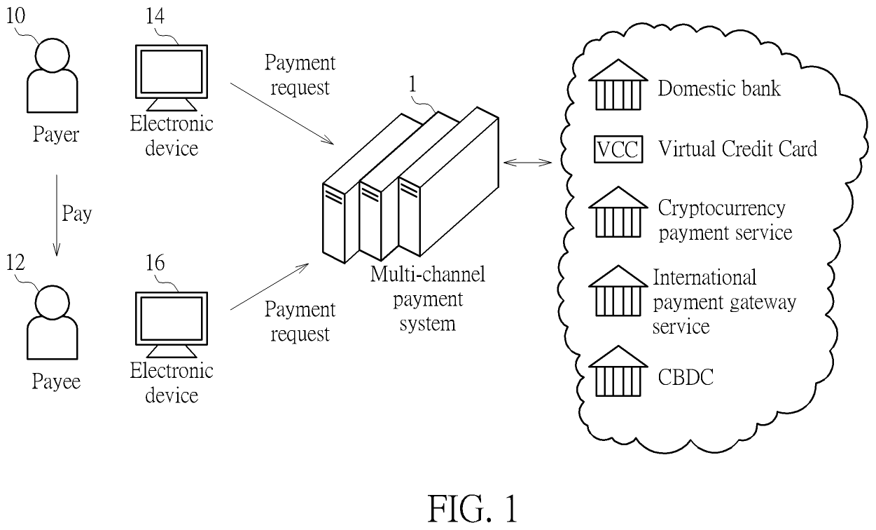

Please refer to FIG. 1, which is a schematic diagram of a multi-channel payment system 1 according to an embodiment of the present invention. As shown in FIG. 1, a payer 10 or a payee 12 uses an electronic device 14 or an electronic device 16 to log in to the multi-channel payment system 1 through a network connection. After initiating a payment request, the payer 10 performs the payment operation corresponding to the payment request to the payee 12 through the multi-channel payment system 1. The electronic device 14 and the electronic device 16 may respectively be a personal computer, a notebook computer, a tablet computer, a mobile phone, or other devices that are capable of accessing the Internet, but are not limited thereto. The multi-channel payment system 1 may integrate various heterogeneous payment gateways. For example, domestic transactions may carry out transfer operations between local banks, and cross-border transactions may use telegraphic transfers (wire transfer), virtual credit card (VCC), digital money transfer and other third-party payment service providers, such as international payment gateway service, cryptocurrency payment service, etc. In addition, not only the fiat currency, the multi-channel payment system 1 may also support the payment operations of various digital money, such as stablecoins (USD Coin, EURO Coin, Tether, Terra Classic USD), central bank digital currency (CBDC), etc.

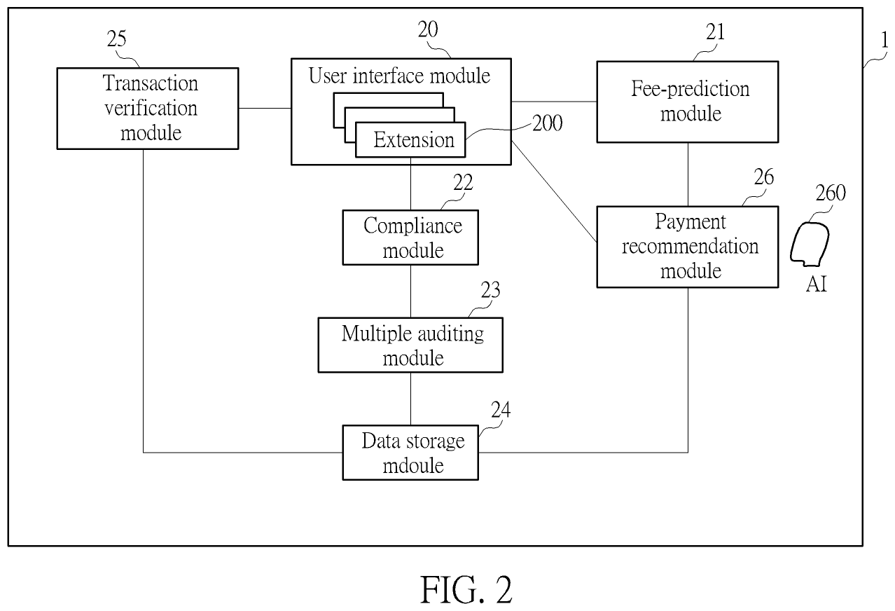

Please refer to FIG. 2, which is a schematic diagram of an architecture of the multi-channel payment system 1 according to an embodiment of the present invention. As shown in FIG. 2, the multi-channel payment system 1 comprises a user interface module 20, a fee-prediction module 21, a compliance module 22, a multiple auditing module 23, a data storage module 24, a transaction verification module 25 and a payment recommendation module 26. The user interface module 20 connects to the fee-prediction module 21, the compliance module 22, the payment recommendation module 26 and the transaction verification module 25, and is modularized by a plurality of extensions 200 for generating an order and executing the payment for the order. The fee-prediction module 21 connects to the user interface module 20 and the payment recommendation module 26, and is used for determining at least one predicted remitting fee, an exchange rate, and a predicted time spent for the order. The compliance module 22 connects to the user interface module 20 and the multiple auditing module 23, and is used for confirming the identity of the payer 10 or the payee 12 and for verifying the order. The multiple auditing module 23 connects to the compliance module 22 and the data storage module 24, and is used for reviewing and permitting the order. The data storage module 24 connects to the multiple auditing module 23, the transaction verification module 25 and the payment recommendation module 26, and is used for storing data generated or received by each module of the multi-channel payment system 1. The transaction verification module 25 connects to the user interface module 20 and the data storage module 24, and is used for verifying payment results. The payment recommendation module 26 connects to the fee-prediction module 21, the user interface module 20 and the data storage module 24, and is used for recommending a payment service for the payer 10 or the payee 12. In this embodiment, each module may be one or more programs/applications or a part of a program/application, which may be executed by the same or multiple processors. It should be noted that the architectural arrangement of each module shown in FIG. 2 is used to illustrate the spirit of the present invention, and those skilled in the art may adopt appropriate design patterns and architectures to implement the multi-channel payment system 1 according to different requirements of platforms, development tools and actual situations.

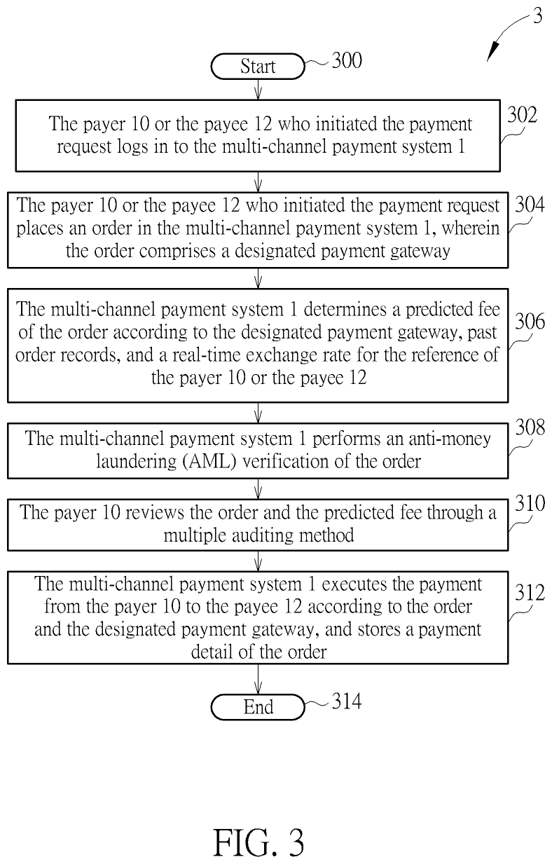

In the embodiment of the present invention, the multi-channel payment system 1 may implement a multi-channel payment method. For example, the payer 10 may actively initiate a payment request and directly pay the payee 12 through the multi-channel payment system 1. Alternatively, the payee 12 may initiate the payment request, and the payer 10 receiving the payment request may decide to accept the payment request and then make payments, or reject the payment request and return the payment request to the payee 12. Specifically, the multi-channel payment method may be summarized into a process 3 as shown in FIG. 3. The process 3 comprises the following steps:
Step 300: Start.
Step 302: The payer 10 or the payee 12 who initiated the payment request logs in to the multi-channel payment system 1.
Step 304: The payer 10 or the payee 12 who initiated the payment request places an order in the multi-channel payment system 1, wherein the order comprises a designated payment gateway.
Step 306: The multi-channel payment system 1 determines a predicted fee of the order according to the designated payment gateway, past order records, and a real-time exchange rate for the reference of the payer 10 or the payee 12.
Step 308: The multi-channel payment system 1 performs an anti-money laundering (AML) verification of the order.
Step 310: The payer 10 reviews the order and the predicted fee through a multiple auditing process.
Step 312: The multi-channel payment system 1 executes the payment from the payer 10 to the payee 12 according to the order and the designated payment gateway, and stores a payment detail of the order.
Step 314: End.

In the process 3, a user of the multi-channel payment system 1 (namely the payer 10 or the payee 12) would need to log in to the multi-channel payment system 1 (Step 302), and only on this premise can a payment request be initiated. If the executed login is for the first time, the user may need to create an account and then activate at least one payment gateway before initiating a payment request. The payment gateway activation in each payment gateway service may require the user to fill in personal information and merchant information, and such information may be verified by a Know Your Customer (KYC) verification. Specifically, it may be required to notify a financial supervisory commission when the user has been involved in the financial criminal act. The user interface module 20 may show a dummy server error page without alerting the suspected user when the personal information of the user fails to pass the KYC verification. The payment request may be initiated by the payer 10 or the payee 12. When a transaction partner (when the payment request is initiated by the payer 10, the transaction partner is the payee 12; when the payment request is initiated by the payee 12, the transaction partner is the payer 10) does not have an account registered in the multi-channel payment system 1, the user may send an invitation to the transaction partner for creating an account through the multi-channel payment system 1. The user initiates the payment request by placing an order and designating a payment gateway (Step 304), and the multi-channel payment system 1 determines a predicted fee of the order according to the designated payment gateway, past order records and a real-time exchange rate for the payer 10 or the payee 12 as a reference (Step 306). When the payment request is initiated by the payee 12, the multi-channel payment system 1 sends the payment request to the payer 10. After the payer 10 receives the payment request, the multi-channel payment system 1 will perform an anti-money laundering (AML) verification on the order according to the laws and regulations of various countries (Step 308). The AML verification is usually made by some external compliance solution providers, which maintain a database of risk and fraud list. The order that has passed the AML verification may enter a multiple auditing process, and the order that fails to pass the AML verification and the user who initiates this order may be blocked. Specifically, the user interface module 20 may show a transaction failure information page when the order fails to pass the AML verification. In the multiple auditing process, a plurality of reviewers jointly decide whether to permit the order for payment (Step 310). After the multiple auditing process, the multi-channel payment system 1 performs the payment remittance operation according to the content of the order and the designated payment gateway and stores the payment result as a payment detail. The payment detail records a payment exchange rate and a related handling fee for successful payment, and stores a cause for payment failure (Step 312).

Accordingly, the multi-channel payment system 1 may be used for both the push payment method and the pull payment method, so that the payer or the payee may flexibly initiate payment requests. Moreover, the multi-channel payment system 1 integrates a variety of heterogeneous payment modes to improve the flexibility of payment operations, and provides robust verification and auditing mechanism to ensure the stability and security of payment.

In detail, in Step 302, the user has to log in to the multi-channel payment system 1. The user may log in through a single sign-on (SSO) service or create an account for the first login. For the first login, the user needs to input user information in a user interface provided by the user interface module 20. The user information at least needs to comprise nationality information or company location information. If the user is an individual user, the user information also needs to comprise information related to identity verification while activating a payment gateway service for the first time; if the user is an enterprise, the user information also needs to comprise information related to company verification while activating the payment gateway service for the first time. After the user registers in the multi-channel payment system 1, the user needs to select at least one payment gateway to activate for the subsequent payment process. During this process, the payment recommendation module 26 provides at least one available payment gateway for the user to select and activate according to the nationality information from the Internet Protocol address (IP address) of the user logging into the multi-channel payment system 1, and the compliance module 22 performs identity verification on the user information. In this embodiment, the identity verification adopts Know Your Customer (KYC) verification, but is not limited thereto. In one embodiment, the payment gateway services can be considered as nodes in a blockchain system, the payment recommendation module 26 may broadcast a payment launch ping to all the connectable nodes (payment gateway services) and recommend the node having the fastest response replying to the payment launch call to the user at the moment when the user initiates the payment request. In another embodiment, the payment recommendation module 26 may also recommend the payment gateway service which executes and completes the remittance within the shortest time spent. All registered users are needed to be complianced by the KYC verification for enabling the payment gateway service. In addition, if the transaction partner does not have an account in the multi-channel payment system 1, an invitation to establish an account may be sent through the multi-channel payment system 1. The form of sending the invitation to create an account may be a message with an Internet hyperlink through an e-mail, a short message service (SMS), QR code (Quick Response Code), etc., and is not limited thereto.

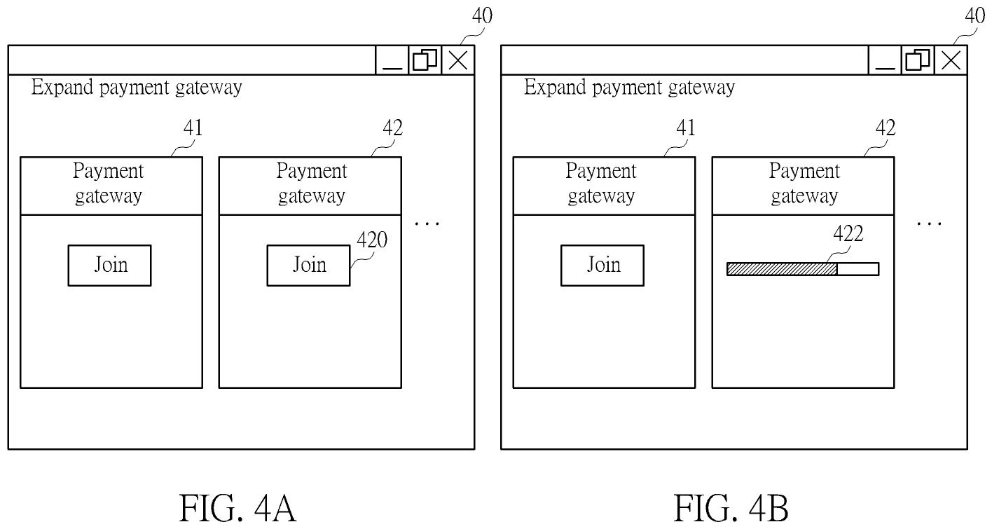

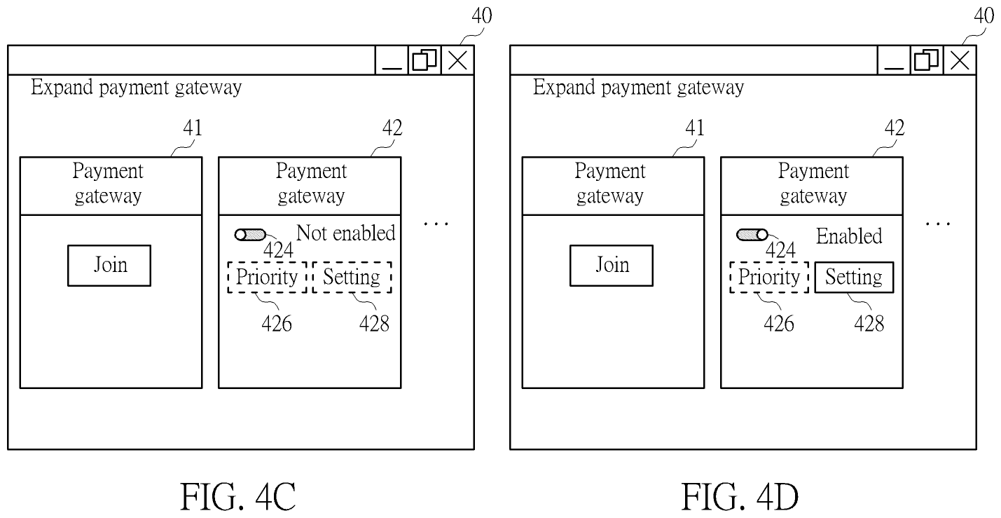

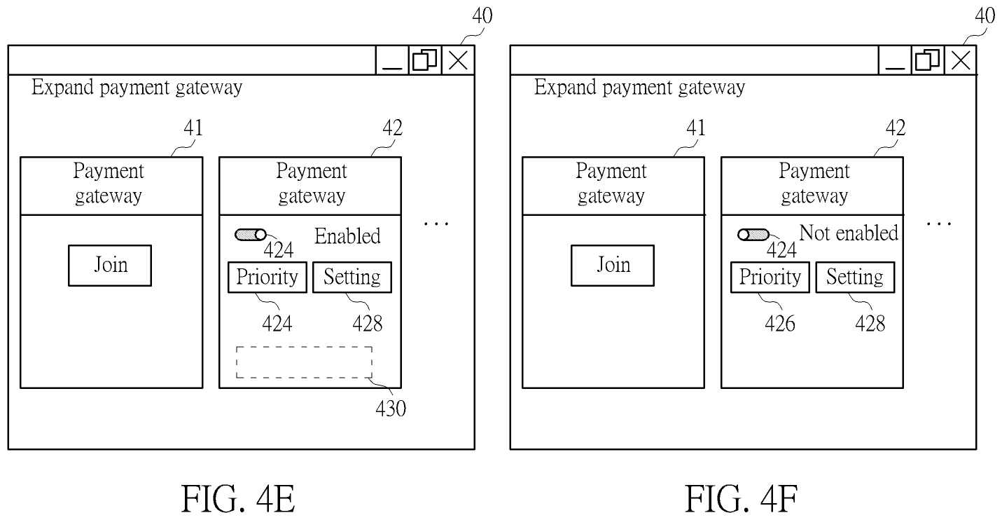

Please refer to FIG. 4A to FIG. 4F, which are schematic diagrams of a user interface 40 for the multi-channel payment system 1 to provide at least one available payment gateway for the user to select and activate. The user interface 40 may be displayed through a web browser on the electronic device 14 or the electronic device 16, or presented as an application on the user device. The user interface 40 is constructed in a form of a series of plug-ins (plugins), add-ins (addins), add-ons (addons), widgets or extensions that correspond to a plurality of payment gateways. Each of the series of plug-ins, add-ins, add-ons, widgets or extensions implements/encapsulates the application programming interfaces (APIs) of a payment channel, and each payment channel represents a payment service which provides a corresponding payment gateway. The payment gateways may be and not limited to domestic banks, international payment services, VCC, etc., and may be recommended by the payment recommendation module 28. Moreover, the user interface module 20 further provides add-ons such as an electronic wallet add-on for a digital currency payment service and a CBDC electronic wallet add-on for a digital currency payment service supporting CBDC. The digital currency could be stablecoin, which is a cryptocurrency where the price can be anchored or pegged to an asset. Generally the stablecoin is pegged to fiat money, such as USD or EURO, and is based on the value of the fiat backing, so as to ensure the value being stable to the fiat money. For the sake of market liquidity, the stablecoin could be based on various smart contracts corresponding to blockchains thereof. The electronic wallet add-on is used to deposit and withdraw digital currency and cooperates with the extension corresponding to the digital currency payment service. The electronic wallet add-on can include a custodial typed wallet and a non-custodial typed wallet. The difference between the custodial typed wallet and the non-custodial typed wallet is who holds the private key which gives the authorization to transfer funds from the electronic wallet add-on. The private key of the custodial typed wallet is managed by a third party that charges the security, backup, and recovery function for the electronic wallet add-on. The private key of the non-custodial typed wallet is held by the user, so that the user has to manage the security and backup of the private key. Also, the non-custodial typed wallet may not be recovered if the user loses the private key. The electronic wallet add-on at least supports the Ethereum ERC-20, Algorand ASA, Avalanche ERC-20, Flow FT, Hedera SDK, Solana SPL, Stellar asset, Polygon ERC-20/PoS, and TRON TRC-20. For example, the payer can deposit one thousand USD stablecoins in the extension of the digital currency payment gateway from the payer's electronic wallet add-on, and generates a payment order of remitting five hundred USD stablecoins to the payee through the extension, as aforementioned, the payment order is verified by the compliance module 22 and is optionally allowed by the multiple auditing module 23 to permit the payment order before the remittance. Wherever the blockchain it is, the transactions of the stablecoins between the electronic wallet add-ons on the multi-channel payment system 1 are recognized by the blockchain address of electronic wallet add-ons if the blockchain is supported by the electronic wallet add-on, so that the payer or payee can transfer the digital asset to each other without choosing the correct smart contract.

Regarding central bank digital currency (CBDC), which is a programmable digital currency and is not necessarily based on blockchain, the formality of the CBDC is dependent on the issue bank. The CBDC can be a CBDC based virtual card or a digital currency being available on a particular blockchain. The CBDC wallet add-on can be a CBDC electronic wallet add-on or a CBDC virtual card used to deposit, spend, and withdraw digital currency of CBDC and cooperate with the extension corresponding to the CBDC service. It should be noted that the electronic wallet add-on and the CBDC wallet add-on are also activated if the identity of the user has been verified by the compliance module 22.

As shown in FIG. 4A, the user interface 40 comprises payment gateways 41, 42 represented by extensions. The payment recommendation module 26 provides the available payment gateways 41 and 42 according to the nationality information and the IP address of the user logging in to the multi-channel payment system 1. The user may click “Join” to install/activate the extension corresponding to the payment gateway. Taking the user choosing to activate the payment gateway 42 as an example, the user clicks a join button 420 to start the procedure. As shown in FIG. 4B, the payment gateway 42 displays a progress bar 422 to prompt the installation procedure. In practice, each extension has been already integrated in the multi-channel payment system 1. The progress bar 422 only shows a visual dummy installation procedure to the user without actually installing the extension. After finishing the visual dummy installation procedure, as shown in FIG. 4C, the payment gateway 42 shows an enabling switch 424, a priority button 426 and a setting button 428. When the payment gateway 42 is not enabled, the user interface 40 disables the priority button 426 and the setting button 428, and the user may need to click the enabling switch 424 to enable the payment gateway 42. Next, after enabling the payment gateway 42, the user interface 40 enables the setting button 428 as shown in FIG. 4D. The user may click the setting button 428 for the enabled payment gateway 42 to perform an activation operation of the payment gateway service, such as setting a bank account, an electronic wallet, and the like, for proceeding with the KYC verification. As shown in FIG. 4E, after the KYC verification is passed and the payment gateway 42 is activated, the priority button 426 in the user interface 40 is enabled, which is a priority setting of the payment gateway for performing the payment operation, and the user may set a preferred payment order. Moreover, the payment gateway 42 (extension) further comprises a brief display block 430 to show information such as past order records, a quantity of past orders, a total amount of the past order records, a real-time exchange rate, a notification for completed payment, etc. After the payment gateway 42 is enabled, the user may disable the payment gateway 42 again at any time through the enabling switch 424, as shown in FIG. 4F. Note that, the enabling switch 424 is illustrated as a form of a slider button; however, any type of switch such as a toggle button, a check button and the like is also suitable for the present invention.

The activation operation of the payment gateway involves setting up financial accounts (such as bank accounts, credit card information, electronic wallets, etc.), importing digital certificates/authentications, performing verification procedures, setting the currency used, etc. corresponding to the payment gateways, and there are different setting details for different payment channels. In the embodiment of the present invention, the user interface module 20 comprises an application programming interface communication protocol (API Communication Protocol) to integrate the Application Programming Interface (API) of the payment gateway provided by each payment service provider into an independent extension. The API communication protocol 80 defines essential information of the payment APIs for communicating between the payment APIs of the multiple payment gateway services and the extensions of the multi-channel payment system. The API communication protocol 80 also verifies an authentication token that a user gets from the designated payment gateway service for authorizing the payment remittance according to the payment order. Accordingly, as shown in FIG. 4A to FIG. 4F, the user may feasibly activate the payment gateway and enable/disable the payment gateway as required.

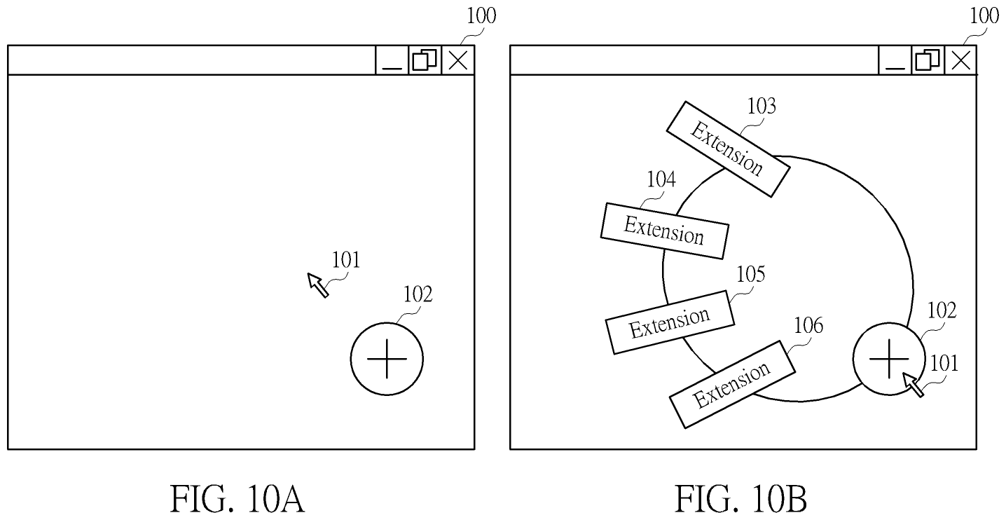

Furthermore, the user interface module 20 comprises a floating button for quickly accessing payment gateways. Please refer to FIG. 10A and FIG. 10B, which are schematic diagrams of the user interface 100. The user interface 100 may be displayed through a web browser on the electronic device 14 or the electronic device 16, or presented as an application on the user device. The user interface 100 comprises a floating button 102, and a cursor 101 controlled by the user. While the cursor 101 is far from the floating button 102, the floating button 102 is in the form of an icon and located in a corner of the user interface 100. While the cursor 101 is move over the floating button 102, the floating button 102 expands to show floating buttons 103-106. Each of the floating buttons 103-106 are connecting to a payment gateway such as payment gateways 41, 42 shown in FIG. 4A to FIG. 4F. The user may set preferred extensions (payment gateways) for floating buttons 103 and 104, a commonly used payment gateway for floating buttons 105, a payment gateway recommended by the multi-channel payment system for floating buttons 106, and is not limited thereto. Through the floating button 102, the user may configure the payment gateway or initiate a new order efficiently.

According to the process 3, in Step 304, the payer 10 or the payee 12 may initiate the payment request in the multi-channel payment system 1. For example, the payer 10 (such as a merchant) may generate an order to proactively make a payment to the payee 12 (such as a supplier), and alternatively the payee 12 may also generate an order to request the payer 10 to pay. After logging in the multi-channel payment system 1, the user may initiate the payment request through the user interface module 20. To initiate the payment request, the user requests to designate the payment gateway and create a preferred payment order set. The payment gateway may be designated according to the recommendation from the payment recommendation module 26. The order contains at least payer information, payee information, a payment amount, and the payment channel provided by the payment gateways (which are implemented/encapsulated by the extensions). The payer and payee information are related to the payment gateway services. For example, when the payment gateway service is a virtual card service, the contents of the order include a virtual credit card number, an expiring period, and an amount of credit limit. In addition, the payment result received from the virtual card service by the transaction verification module 25 includes purchase time, a credit card charging fee, a credit card statement, and an outstanding balance from the virtual credit card service. When the payment gateway service is a digital currency payment service, the contents of the order include electronic wallet addresses of the payer and the payee, a payment amount, and a transaction fee (gas fee). When the payment gateway service is a domestic or cross-border remittance service, the contents of the order include bank accounts of the payer and the payee, the payment amount, and the remittance purpose (if it is required on a basis of receiver's local bank law). When the payment gateway service is a digital currency payment service supporting CBDC, the contents of the order may include CBDC electronic wallet addresses of the payer and the payee, the CBDC supported bank accounts of the payer and the payee, and the payment amount. Moreover, if the payment of CBDC is in the form of a virtual CBDC card, the order may include a virtual card number, an amount of CBDC limit, an expiration date, and a CBDC security code.

The payer and payee of every transaction are required to be verified by a KYC verification of the compliance module 22, if the transaction partner has not activated the designated payment gateway, the one who initiating the transaction may send an invitation to the other of the transaction partner for activating the designated payment gateway through the multi-channel payment system 1. The invitation to activate the designated payment gateway may be a message with an Internet hyperlink transmitted through an email, an SMS, a push notification of an application, etc., and is not limited thereto.

In an embodiment, the payment recommendation module 26 recommends payment gateways according to the nationality information of the payer 10 and the payee 12 and the IP addresses of the payer 10 and the payee 12 logging into the multi-channel payment system 1 for determining the current available payment gateways (in form of extensions). In an embodiment, the payment recommendation module 26 further comprises an artificial intelligence (AI) model 260 or machine learning (ML) model that recommends those available payment gateways according to an AI algorithm. By accessing the preceding order records and transaction details of the data storage module 24, the AI model 260 is able to obtain information such as the purpose of the payment, the user's past preferences, and the reasons for successful or unsuccessful payment. In addition, the AI algorithm further determines the recommendation on a basis of dominant variables and latent variables with different weightings. The dominant variables include at least one of national regulations, asset level, risk tolerance and personal/company credit; the latent variables include at least one of user past preference, industry preference and payment purpose. The dominant variables and the latent variables are used as the training features of the AI model to recommend payment gateways. In an embodiment, the payment recommendation module 26 may further obtain the predicted fee of each payment gateway through the fee-prediction module 21, and recommend payment gateways accordingly. In another embodiment, the payment recommendation module 26 may further obtain an estimated time spent which each payment gateway completes the payment through the fee-prediction module 21, and recommend payment gateways accordingly. The payment recommendation module 26 sorts the recommended payment gateways according to a transaction cost or a time spent, but not limited thereto, as a sorting reference. The payment recommendation module 26 authorizes the user interface module 20 to display a sorted result of the recommended payment gateways when the user logs in the multi-channel payment system 1 or initiates a new payment order.

According to the process 3, in Step 306, the multi-channel payment system 1 determines a predicted fee of the order based on the designated payment gateway, past order records and a real-time exchange rate for the user who initiates the order as reference. In detail, the data storage module 24 stores all past orders and payment details, including transaction-related information such as a payment amount, an exchange rate, and a handling fee. The fee-prediction module 21 obtains the real-time exchange rate from the payment service provider providing the designated payment gateway, and predicts the fee of the order according to the relevant order records of the data storage module 24 and the real-time exchange rate. Finally, the predicted fee is presented to the user for reference.

In an embodiment, the fee-prediction module 21 may obtain the real-time exchange rate information from the service providers of each payment gateway at regular intervals. For example, a query command may be sent to the server of the service provider of each payment gateway every 15 minutes, and the obtained exchange rate may be stored. When predicting the fee, the fee-prediction module 21 may predict the fee according to the exchange rate obtained from the last query. In another embodiment, the fee-prediction module 21 may send a query command to the server of the service provider of the designated payment gateway when the fee-prediction module 21 performs the fee prediction. Those skilled in the art may adjust the mode and the frequency for obtaining the exchange rate according to business requirements.

In an embodiment, the multi-channel payment system 1 may further perform a verification process when determining to send a payment request. Specifically, the multi-channel payment system 1 may verify the order originator through a two-factor authentication (2FA), a multi-factor authentication (MFA) or other verification methods to ensure security. The user may set criterions for the order to be verified in the multi-channel payment system 1, such as a threshold value for the payment amount, the transaction partner, the payment type, etc., to ensure that there is no risk of fraudulent use for high-value payments or orders related to major decisions.

According to the process 3, in Step 308, the multi-channel payment system 1 needs to perform AML verification. In detail, the compliance module 22 performs AML verification according to the financial accounts and transaction behaviors of the payer 10 and the payee 12 related to the designated payment gateway. The AML verification is used to make sure whether the payment request is a legitimate business, which should comply with the laws and the regulations of various countries and be carried out before executing the payment. Only the order that has passed AML verification is allowed to enter a multiple auditing process.

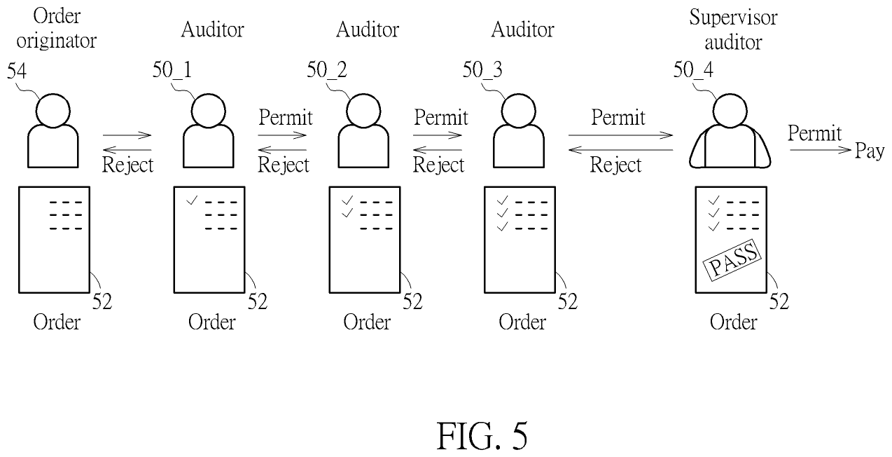

In Step 310, the multi-channel payment system 1 may start a multiple auditing process for the order that has passed AML verification. In detail, in an embodiment, the multiple auditing module 23 provides a user interface, and the user may review the order content, the designated payment gateway and the predicted fee through the user interface. In the embodiment of the present invention, the multi-channel payment system 1 provides the flexibility to set the auditing authority and the auditing process, which adapts to the financial personnel of various company organizations and is convenient for the financial personnel to quickly deploy and use. In addition, in an embodiment, the user may set criterions for an automatic payment through the multi-channel payment system 1, and the orders that meet the criterions are allowed to directly proceed to Step 312 for executing payment without audit. The criterions for the automatic payment may be a threshold value for the payment amount, the transaction partner, the payment type, etc., and is not limited thereto. Specifically, the user account of the multi-channel payment system 1 may include multiple sub-accounts, and the company may set up different authorities for each sub-account to conduct different levels of audit. Moreover, according to different requirements of each company, the auditing process for the order may be performed in the way of a linear auditing process, a group meeting auditing process or a ring signature auditing process. In an embodiment, the merchant or the supplier may create multiple sub-accounts for multiple auditors. As shown in FIG. 5 to FIG. 7, an order 52 is jointly reviewed by auditors 50_1, 50_2, 50_3 and a supervisor auditor 50_4, and the order 52 is allowed to be executed only if passing the multiple auditing process. The embodiment of the present invention takes four auditors as an example, including three general auditors and a supervisor auditor, which, however, is not limited thereto. It should be noted that the multiple auditing process in the embodiment of the present invention could be used for both the payer 10 and the payee 12 at the same time. For example, before the payment request initiated by the payee is sent to the payer, the related auditing personnel of the payer 10 may go through a first multiple auditing process to decide whether to send it. On the other hand, the payer who has received the payment request could decide whether to execute the payment or not through a second multiple auditing process by the related auditing personnel of the payee 12. Furthermore, in an embodiment, the electronic wallet add-on and the CBDC wallet add-on may have a 2FA or MFA verification or may need to be verified by an authentication of the single sign-on (SSO) service for managing the use thereof. The multiple auditing module 23 may connect to the electronic wallet add-on and the CBDC wallet add-on for control the use thereof via the 2FA or the MFA verification while permitting the order.

In an embodiment, the merchants or the suppliers may perform a linear auditing process (a multi-person and single-line process) through the multiple auditing module 23 as shown in FIG. 5. After an order originator 54 places the order 52, the order 52 needs to go through AML verification first. The order 52 that has been verified successfully is sent to the auditor 50_1 for reviewing and deciding whether to permit or reject the order 52. If the auditor 50_1 permits the order 52 by passing through the 2FA or MFA verification, the order 52 is sent to the next auditor 50_2 through the multi-channel payment system 1; if not, the order 52 is returned to the order originator 54 through the multi-channel payment system 1. After receiving the order 52 from the auditor 50_1, the auditor 50_2 reviews the order 52 and decides whether to permit or not; if yes, the order 52 is sent to the next auditor 50_3; if not, the order 52 is returned to the auditor 50_1. Similarly, after receiving the order 52 from the auditor 50_2, the auditor 50_3 reviews the order 52 and decides whether to permit or not; if yes, the order 52 is sent to the supervisor auditor 50_4; if not, the order 52 is returned to the auditor 50_2. Finally, the supervisor auditor 50_4 checks the order 52 and decides whether to permit it or not. If yes, the multi-channel payment system 1 determines that the order 52 has passed the auditing process and executes the payment according to the designated payment gateway; if not, the order 52 is returned to the auditor 50_3. In this embodiment, the order 52 is reviewed in sequence by the auditor 50_1, the auditor 50_2, the auditor 50_3 and the supervisor auditor 50_4, which decide whether to permit the order 52.

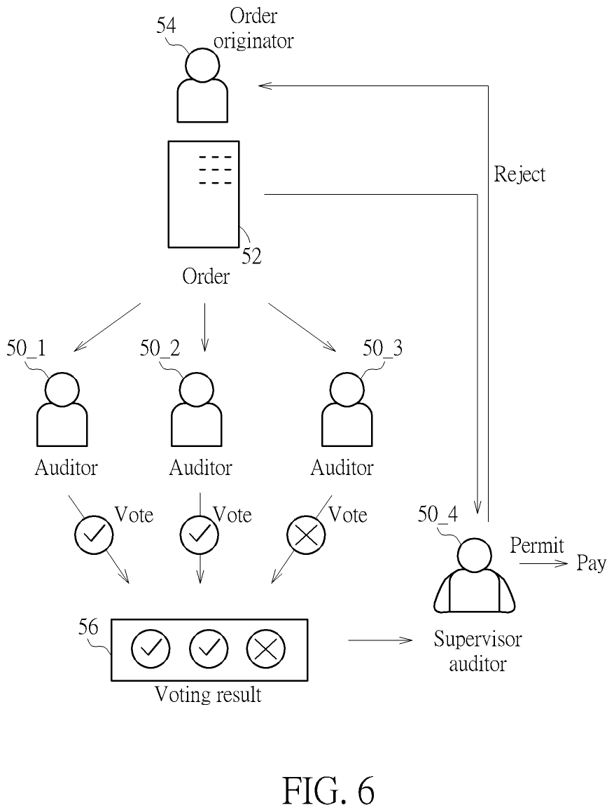

In another embodiment, the merchants or the suppliers may perform a group meeting auditing process (a multi-person and multi-line process) through the multiple auditing module 23 as shown in FIG. 6. After the order originator 54 places the order 52, the order 52 needs to go through AML verification first. The order 52 that has been verified successfully is simultaneously sent to the auditor 50_1, the auditor 50_2 and the auditor 50_3, and then the auditor 50_1, the auditor 50_2 and the auditor 50_3 check the order 52 and vote through the multi-channel payment system 1. Before and during the voting, anyone of the auditors 50_1-50_4 can designate another one to express the auditing opinion for communicating and exchanging auditing opinions through the multiple auditing module. The order 52 and a voting result 56 are sent together to the supervisor auditor 50_4. The supervisor auditor 50_4 reviews the order 52 and the voting result, and then conducts a final review accordingly for ending the group meeting auditing process. If the supervisor auditor 50_4 permits the order 52, the multi-channel payment system 1 determines that the order 52 has passed the auditing process and executes the payment according to the designated payment gateway (after a 2FA or MFA verification); if not, the order 52 is returned to the order originator 54.

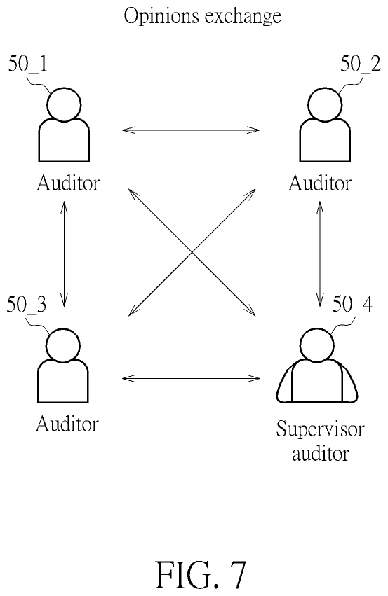

Furthermore, the multiple auditing module 23 provides a user interface for online exchange of auditing opinions. As shown in FIG. 7, when any one of the auditor 50_1, the auditor 50_2, the auditor 50_3, and the supervisor auditor 50_4 has any doubts about the content of the order 52, an exchange of opinions may be carried out through the multi-channel payment system 1. The exchange of opinions may be in the form of one-to-one, one-to-many, many-to-many, etc., which provides a highly adaptable and strict auditing process, since any auditor can designate other auditors to express the auditing opinion. Accordingly, the multiple auditing module 23 may be flexibly adjusted depending on a configuration of a finance department of a merchant/supplier's company, and the auditing process may be the linear auditing process, the group meeting auditing process, or even the ring signature auditing process, and is not limited thereto.

According to the process 3, in Step 312, the multi-channel payment system 1 executes the payment from the payer 10 to the payee 12 according to the order and the designated payment gateway, and stores a payment detail of the order. In detail, after the order is permitted, the multi-channel payment system 1 may enter a payment process. The extension 200 executes the payment operation according to the order content and the designated payment gateway, and the transaction verification module 25 verifies the result of the payment operation. Specifically, the transaction verification module 25 interacts with the extension 200 of the user interface module 20 and the data storage module 24, and thereby receives a status of the payment from the service provider of the designated payment gateway service. The transaction verification module 25 stores the execution result of the payment operation in the payment detail and shows the payment result by the user interface module 20. There are many factors in the payment process that may cause the payment operation to fail; for example, the balance on the bank account of the payer 10 is insufficient, the service provider that provides the payment gateways does not function properly (such as network problems), etc. When the extension is the digital currency payment, the transaction may fail because of many reasons, such as blockchain node error, insufficient gas price, frequent transaction in a certain period, block missing, or blockchain fork, and it is required to transfer the payment result to the transaction verification module 25 and may redo the transaction (authorized by the payer). The transaction verification module 25 not only records the details of the payment operation, such as remittance fee, final exchange rate, time spent (including transferring time and arrival time), etc., but also records the factors of payment failure in detail and stores them in the data storage module 24. The fee-prediction module 21 may predict the fee of subsequent orders according to data provided by the data storage module 24, such as the relevant order records, payment fees, exchange rates, etc., and the real-time exchange rate provided by the service provider of the designated payment gateway. The payment recommendation module 26 may recommend payment gateways for subsequent orders according to the relevant order records provided by the data storage module 24, including payment details, such as fees, exchange rates, and reasons for payment failure.

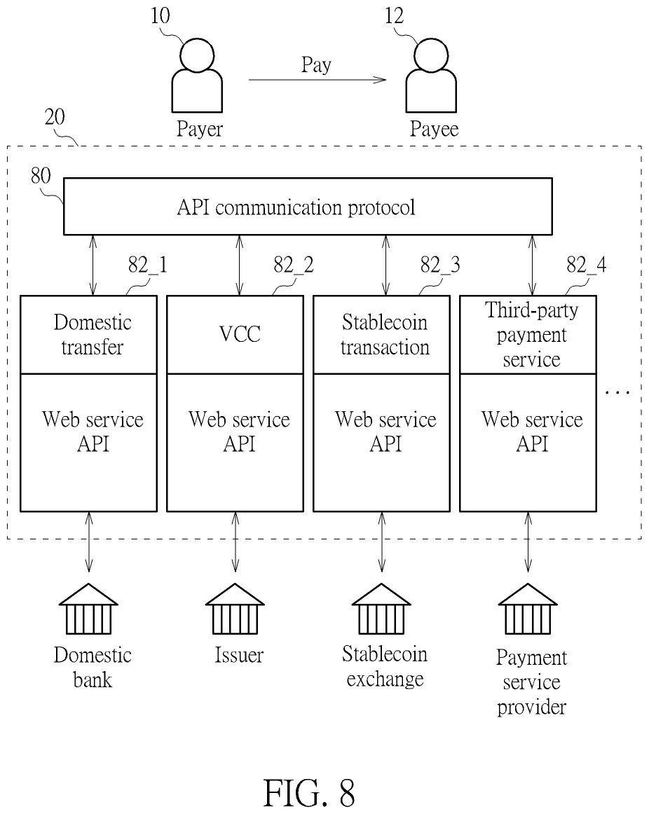

Regarding the operation of the user interface module 20, in practice, an API communication protocol 80 may also be provided as shown in FIG. 8. Through the API communication protocol 80, the multi-channel payment system 1 integrates various heterogeneous payment gateways, such as a domestic transfer 82_1, a VCC transaction 82_2, a stablecoin transaction 82_3 and a third party payment service 82_4, etc. As shown in FIG. 8, the API protocol 80 establishes an abstraction layer to integrate the service API provided by the service provider of each payment gateway by defining an API shown in following Table 1, thereby wrapping/encapsulating each payment gateway as an independent extension. In other words, the API communication protocol 80 defines essential data formats for mapping the service APIs to the extensions of the user interface module 20. The data formats defined by the API communication protocol 80 are flexible to match with the APIs of the similar payment gateway services and are expandable to scale-out new types of services. The API communication protocol 80 verifies an authentication token from the payment gateway service to allow receipt and payment transactions, so that the multiple auditing module 23 permits the payment order by using the API communication protocol 80 to perform the payment operations between the finance services. In this way, when developers integrate a new payment gateway, the new payment gateway may be integrated into the multi-channel payment system 1 in a modular manner, and users of the multi-channel payment system 1 may quickly join, select, enable or disable each payment gateway as shown in FIG. 4A to FIG. 4F. Note that, the API functions shown in Table 1 are only used to illustrate the concept of the present invention, and detailed parameters, return values, and related data structures should be defined according to actual requirements. Moreover, the API needs to include the basic functions of various payment gateways. In response to the huge differences between various heterogeneous payment gateways, the definition of the API is necessary to expand according to the actual situation.

TABLE 1

| | |
|---|---|
| API Function | Description |

Interface for Payout Gateway

| | |
|---|---|
| setPayouts ( ) | Set an order |
| getPayouts ( ) | Get an order |
| getFee ( ) | Get a transaction fee |
| getAccount ( ) | Get an account |
| getRecords ( ) | Get records |

Interface for Cross Border Payout Gateway

| | |
|---|---|
| getExchangeRate ( ) | Get an exchange rate |
| getExchangeRateProvider ( ) | Get the provider of exchange |
| | rate |

Accordingly, the present invention highly integrates payment-related services, particularly, the payment services with totally different natures. The multi-channel payment system 1 concatenates the functions of placing an order, identification verifying, fee-related prediction, gateway recommendation, reviewing order and executing payment, etc., so as to provide the user with a smooth use experience. In addition, the multi-channel payment system 1 integrates domestic banks, cross-border transfers, cryptocurrency transfers, virtual credit cards, and many other payment services with completely different usage scenarios. Users may feasibly select payment channels or currencies according to their needs. The payer or the payee can readily initiate batches of various different payment orders based on heterogeneous payment gateway and easily manage the payments in batches with different countries all in the multi-channel payment system 1 of the present invention, so that the payer/payee can deal with the payments of various billing cycles by using a single financial system. Moreover, the payment services are packaged through API communication protocol to provide the flexibility to integrate new payment services in response to the rapid changes and development of current and future transaction modes.

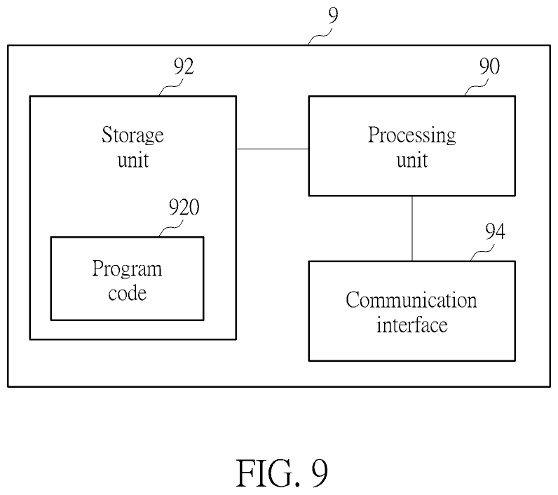

For implementation, please refer to FIG. 9, which is a schematic diagram of a device 9 according to an embodiment of the present invention. The device 9 may be used to implement the multi-channel payment system 1 or any one of the modules thereof, and includes a processing unit 90, a storage unit 92 and a communication interface unit 94. The processing unit 90 may be a microprocessor or an application-specific integrated circuit (ASIC). The storage unit 92 may be any type of data storage devices for storing a program code 920, and the program code 920 is read and executed by the processing unit 90. For example, the storage unit 92 may be a read-only memory (ROM), a flash memory, a random-access memory (RAM), a hard disk, an optical data storage device, a non-volatile storage unit, etc., and is not limited thereto. The communication interface unit 94 may be used to transmit messages with other devices or users through wired or wireless communication.

The device 9 is used to represent the necessary components required to implement the embodiments of the present invention, and those skilled in the art may make various modifications and adjustments accordingly, and is not limited to this. For example, when the device 9 is applied to implement the multi-channel payment system 1, the process 3 may be compiled into the program code 920, stored in the storage unit 92, and executed by the processing unit 90. And, through the communication interface unit 94, information is transmitted with other devices. When the device 9 is applied to implement the data storage module 24, data storage could be implemented by a database or a blockchain method. Specifically, data related to orders, user information, etc. could be stored in the storage unit 92, and the data access method could be compiled into the program code 920, stored in the storage unit 92. The data access method could be executed by the processing unit 90, and information is transferred with other modules through the communication interface unit 94. It should be noted that FIG. 9 is only used to illustrate the concept of the present invention. The details of the communication method between devices or modules, the data structure of data storage, etc., could be adjusted according to actual requirements by those skilled in the art, so it is not repeated here.

In summary, the present invention provides a highly integrated multi-channel payment system. The multi-channel payment system may be used for both the push payment method and the pull payment method, and both of payers and payees could initiate payment requests flexibly. The multi-channel payment system may support domestic or cross-border payments in multiple currencies, and provides a modularized payment gateway interface, which efficiently integrates payment gateways and improves the utilization convenience. Furthermore, a multiple auditing method is provided to simplify the auditing process for payment review. The multi-channel payment system provided by the present invention enables users to perform payment operations smoothly without dealing with complicated payment details and without security concerns.

Those skilled in the art will readily observe that numerous modifications and alterations of the device and method may be made while retaining the teachings of the invention. Accordingly, the above disclosure should be construed as limited only by the metes and bounds of the appended claims.

1. A multi-channel payment system, wherein the multi-channel system integrates multiple payment gateway services for providing domestic remittance, cross-border remittance, virtual credit card, and digital currency remittance, the multi-channel payment system comprising:
a processing unit; and
a storage unit, for storing a program code, wherein the program code instructs the processing unit to execute a machine-implemented method, and the machine-implement method comprises:
executing, by a user interface module modularized by a plurality of extensions, payment from a payer to a payee according to a payment order placed by the payer or payee;
wherein each single extension of the plurality of extensions represents a payment channel connected with one of the multiple payment gateway services via an application programming interface (API) communication protocol defining essential information of payment APIs from the multiple payment gateway services;
each extension is selectively activated by the payer or payee and is enabled when an identity of the payer or payee has been verified, the extension generates the payment order placed by the payer or payee to initiate a payment request, and
the API communication protocol communicates between the payment APIs of the multiple payment gateway services and the multi-channel payment system, wherein the API communication protocol verifies an authentication token to communicate with the payment gateway services and allow a payment remittance of the payment order;
determining, by a fee-prediction module feeding data to the user interface module, at least one of a predicted remitting fee, an exchange rate, and a predicted transfer time of the payment order from a designated payment gateway service, past payment order records, and a real-time exchange rate provider;
confirming, by a compliance module communicating with the user interface module, the identity of the payer or payee verified by a Know Your Customer (KYC) verification service while applying the each extension for the first time and for confirming the payment order verified by an anti-money laundering (AML) verification service;
receiving, by a multiple auditing module, the payment order from the compliance module, for reviewing, objecting, or permitting the payment order;
storing, by a data storage module, login information, the identity of the payer or payee, the payment order generated by the each extension, and a payment result when the payment order is permitted by the multiple auditing module; and
receiving, by a transaction verification module interacting with the user interface module and the data storage module, a status of the payment order from the designated payment gateway service and showing the payment result by the user interface module;
wherein the each extension has been integrated in the multi-channel payment system and the payment channel is turned on when a corresponding extension is activated, and the user interface module shows a visual dummy installation when the each extension is activated by the payer or payee for indicating the extension being processed without actually installing the extension to the multi-channel payment system.

2. (canceled)

3. The multi-channel payment system of claim 1, wherein the each extension has an enabling switch to turn on or turn off the payment channel associated with the extension.

4. The multi-channel payment system of claim 1, wherein the user interface module has a floating button for receiving and customizing the plurality of extensions, and the extensions corresponding to preferred payment channels are integrated into the floating button.

5. The multi-channel payment system of claim 1, wherein the each extension has a brief display block to show at least one of the past payment order records, a quantity of past payment orders, a total amount of the past payment order records, a real-time exchange rate, and a notification of a completed remittance from a payment order generated by the each extension.

6. The multi-channel payment system of claim 1, wherein the multiple auditing module performs a linear auditing process, a ring signature auditing process, or a group meeting auditing process for corresponding to a composition of a finance department of the payer or payee, and wherein the multiple auditing module has a two-factor authentication (2FA) or a multi-factor authentication (MFA) verification when the payment order is permitted.

7. The multi-channel payment system of claim 6, wherein the group meeting auditing process performed by the multiple auditing module comprises the following steps:
designating, by any of a plurality of auditors, to another of the plurality of auditors during reviewing the payment order and the predicted remitting fee for communicating and exchanging auditing opinions through the multiple auditing module;
voting, by the plurality of auditors, after reviewing the payment order and the predicted remitting fee through the multiple auditing module so as to make a voting result; and
determining, by a supervisor auditor of the plurality of auditors, whether to permit the payment order after reviewing the payment order, the predicted fee and the voting result for ending the group meeting auditing process.

8. The multi-channel payment system of claim 1, further comprising a payment recommendation module, connected to the user interface module and the fee-prediction module, wherein the payment recommendation module recommends at least one available payment channel to the payer or payee by following steps:
detecting a nationality information based on an IP address of the payer and the payee;
determining the at least one available payment channel according to the nationality information;
sorting the at least one available payment channel according to a transaction cost or a time spent; and
authorizing the user interface module to show a sorted result of the at least one available payment channel on the extension.

9. The multi-channel payment system of claim 8, wherein the step of determining the at least one available payment channel comprises determining the at least one available payment channel by an artificial intelligence (AI) or a machine learning (ML) algorithm on a basis of dominant variables and latent variables with different weightings; wherein the dominant variables include at least one of national regulations, asset level, risk tolerance and personal or company credit, and the latent variables include at least one of user past performance, industry preference and payment purpose.

10. The multi-channel payment system of claim 1, wherein the payment order comprises a payer information, a payee information, a payment amount, and the payment channel represented by a corresponding one of the plurality of extensions; wherein the payer information comprises a payer bank account or a payer electronic wallet address, and the payee information comprises a payee bank account or a payee electronic wallet address.

11. The multi-channel payment system of claim 1, wherein one of the payer or the payee who initiated the payment request sends an invitation to the other for activating a payment channel corresponding to the designated payment gateway service.

12. The multi-channel payment system of claim 1, wherein the payment result received by the transaction verification module comprises:
a final exchange rate, a remittance fee of the designated payment gateway service,
a transferring time, an arrival time, and
a cause for payment failure when the payment order is failed.

13. The multi-channel payment system of claim 1, wherein the designated payment gateway service is a virtual credit card service, a corresponding extension of the user interface module generates the payment order including a virtual credit card number, an expiring period, and an amount of credit limit; wherein the transaction verification module receives purchase time, a credit card charging fee, a credit card statement, and an outstanding balance from the virtual credit card service.

14. The multi-channel payment system of claim 1, wherein the designated payment gateway service is a digital currency payment service, the user interface module further provides an electronic wallet add-on to deposit digital currency in or receive the digital currency from an extension corresponding to the digital currency payment service.

15. The multi-channel payment system of claim 14, wherein the electronic wallet add-on is activated in the multi-channel payment system when the identity of the payer or payee has been verified by the compliance module or has been verified by a single sign-on (SSO) authentication of multi-channel payment system.

16. The multi-channel payment system of claim 14, wherein the multiple auditing module permits the payment order from the electronic wallet add-on to the extension corresponding to the digital currency payment service by checking a two-factor authentication (2FA) or a multi-factor authentication (MFA) verification.

17. The multi-channel payment system of claim 1, wherein the designated payment gateway service is a digital currency payment service supporting central bank digital currency (CBDC), the user interface module further provides a CBDC electronic wallet add-on to deposit CBDC in or receive CBDC from the extension corresponding to the digital currency payment service.

18. The multi-channel payment system of claim 1, wherein the designated payment gateway service is a digital currency payment service for supporting central bank digital currency (CBDC), a corresponding extension of the user interface module generates a virtual CBDC card with the payment order including a virtual card number, an amount of CBDC limit, and a CBDC security code.

19. The multi-channel payment system of claim 1, wherein the API communication protocol defines expandable data formats for mapping the extension of the user interface module to a corresponding one of the multiple payment gateway services.

20. The multi-channel payment system of claim 1, wherein the each extension displays a dummy error page when the identity of the payer or payee fails to be verified by the KYC verification service and displays transaction failure information when the payment order fails to be verified by the AML verification service.

21. A multi-channel payment method, wherein the multi-channel method integrates multiple payment gateway services for providing domestic remittance, cross-border remittance, virtual credit card, and digital currency remittance, the multi-channel payment method is executed by a processing unit and a storage unit for storing a program code which instructs the processing unit, the multi-channel payment method comprising:
executing, by a user interface module modularized by a plurality of extensions, payment from a payer to a payee according to a payment order placed by the payer or payee;
wherein each single extension of the plurality of extensions represents a payment channel connected with one of the multiple payment gateway services via an application programming interface (API) communication protocol defining essential information of payment APIs from the multiple payment gateway services;
each extension is selectively activated by the payer or payee and is enabled when an identity of the payer or payee has been verified, the extension generates the payment order placed by the payer or payee to initiate a payment request; and
the API communication protocol communicates between the payment APIs of the multiple payment gateway services and the plurality of extensions, wherein the API communication protocol verifies an authentication token to communicate with the payment gateway services and allow a payment remittance of the payment order;
feeding, by a fee-prediction module, data to the user interface module for determining at least one of a predicted remitting fee, an exchange rate, and a predicted transfer time of the payment order from a designated payment gateway service, past payment order records, and a real-time exchange rate provider;
confirming, by a compliance module communicating with the user interface module, the identity of the payer or payee verified by a Know Your Customer (KYC) verification service while applying the each extension for the first time and for confirming the payment order verified by an anti-money laundering (AML) verification service;
receiving, by a multiple auditing module, the payment order from the compliance module for reviewing, objecting, or permitting the payment order;
storing, by a data storage module, a login information, the identity of the payer or payee, the payment order generated by the each extension, and a payment result when the payment order is permitted by the multiple auditing module; and
interacting, by a transaction verification module, with the user interface module and the data storage module for receiving a status of the payment order from the designated payment gateway service and showing the payment result by the user interface module;
wherein the each extension has been integrated in the user interface module and the payment channel is turned on when a corresponding extension is activated, and the user interface module shows a visual dummy installation when the each extension is activated by the payer or payee for indicating the extension being processed without actually installing the extension.

22. (canceled)

23. The multi-channel payment method of claim 21, wherein the each extension has an enabling switch button to turn on or turn off the payment channel associated with the extension.

24. The multi-channel payment method of claim 21, wherein the user interface module has a floating button for receiving and customizing the plurality of extensions corresponding to preferred payment channels being integrated into the floating button.

25. The multi-channel payment method of claim 21, wherein the each extension has a brief display block to show at least one of the past payment order records, a quantity of past payment orders, a total amount of the past payment order records, a real-time exchange rate, and a notification of a completed remittance from a payment order generated by the each extension.

26. The multi-channel payment method of claim 21, wherein the multiple auditing module performs a linear auditing process, a ring signature auditing process, or a group meeting auditing process for corresponding to a composition of a finance department of the payer or payee, and wherein the multiple auditing module has a two-factor authentication (2FA) or a multi-factor authentication (MFA) verification when the payment order is permitted.

27. The multi-channel payment method of claim 26, wherein the group meeting auditing process performed by the multiple auditing module comprises following steps:
designating, by any of a plurality of auditors, to another of the plurality of auditors during reviewing the payment order and the predicted remitting fee for communicating and exchanging auditing opinions through the multiple auditing module;
voting, by the plurality of auditors, after reviewing the payment order and the predicted remitting fee so as to make a voting result; and
determining, by a supervisor auditor of the plurality of auditors, whether to permit the payment order after reviewing the payment order, the predicted fee and the voting result for ending the group meeting auditing process.

28. The multi-channel payment method of claim 21, further comprising:
recommending, by a payment recommendation module, at least one available payment channel to the payer or payee by following steps:
detecting a nationality information based on an IP address of the payer and the payee;
determining the at least one available payment channel according to the nationality information;
sorting the at least one available payment channel according to a transaction cost or a time spent; and
authorizing the user interface module to show a sorted result of the at least one available payment channel on the extension.

29. The multi-channel payment method of claim 28, wherein the step of determining the at least one available payment channel comprises determining the at least one available payment channel by an artificial intelligence (AI) algorithm or a machine learning (ML) on a basis of dominant variables and latent variables with different weightings; wherein the dominant variables include at least one of national regulations, asset level, risk tolerance and personal or company credit, and the latent variables include at least one of user past performance, industry preference and payment purpose.

30. The multi-channel payment method of claim 21, wherein the payment order comprises a payer information, a payee information, a payment amount, and the payment channel represented by a corresponding one of the plurality of extension; wherein the payer information comprises a payer bank account or a payer electronic wallet address, and the payee information comprises a payee bank account or a payee electronic wallet address.

31. The multi-channel payment method of claim 21, wherein one of the payer or the payee who initiated the payment request sends an invitation to the other for activating a payment channel corresponding to the designated payment gateway service.

32. The multi-channel payment method of claim 21, wherein the payment result received by the transaction verification module comprises:
a final exchange rate, a remittance price of the designated payment gateway service,
a transferring time, an arrival time, and
a cause for payment failure when the payment order is failed.

33. The multi-channel payment method of claim 21, wherein the designated payment gateway service is a virtual credit card service, a corresponding extension of the user interface module generates the payment order including a virtual credit card number, an expiring period, and an amount of credit limit; wherein the transaction verification module receives purchase time, a credit card charging fee, a credit card statement, and an outstanding balance from the virtual credit card service.

34. The multi-channel payment method of claim 21, wherein the designated payment gateway service is a digital currency payment service, the user interface module further provides an electronic wallet add-on to deposit digital currency in or receive the digital currency from an extension corresponding to the digital currency payment service.

35. The multi-channel payment method of claim 34, wherein the electronic wallet add-on is activated when the identity of the payer or payee has been verified by the compliance module or has been verified by a single sign-on (SSO) authentication of multi-channel payment system.

36. The multi-channel payment method of claim 34, wherein the multiple auditing module permits the payment order from the electronic wallet add-on to the extension corresponding to the digital currency payment service by checking a two-factor authentication (2FA) or a multi-factor authentication (MFA) verification.

37. The multi-channel payment method of claim 21, wherein the designated payment gateway service is a digital currency payment service supporting central bank digital currency (CBDC), the user interface module further provides a CBDC electronic wallet add-on to deposit CBDC in or receive CBDC from the extension corresponding to the digital currency payment service.

38. The multi-channel payment method of claim 21, wherein the designated payment gateway service is a digital currency payment service for supporting central bank digital currency (CBDC), a corresponding extension of the user interface module generates a virtual CBDC card with the payment order including a virtual card number, an amount of CBDC limit, and a CBDC security code.

39. The multi-channel payment method of claim 21, wherein the API communication protocol defines expandable data formats for mapping the extension of the user interface module to a corresponding one of the multiple payment gateway service.

40. The multi-channel payment method of claim 21, wherein the each extension displays a dummy error page when the identity of the payer or payee fails to be verified by the KYC verification service and displays transaction failure information when the payment order fails to be verified by the AML verification service.
